(19) United States
(12) Patent Application Publication
(10) Pub. No.: US 2021/0278076 A1
(43) Pub. Date: Sep. 9, 2021

(54) BLANKET HAVING LIGHTING APPARATUS

(71) Applicant: Intersell Ventures, LLC, Secaucus, NJ (US)

(72) Inventor: Anand A. DHIRMALANI, Secaucus, NJ (US)

(21) Appl. No.: 16/813,399

(22) Filed: Mar. 9, 2020

(51) Int. Cl. F21V 33/00; A47G 9/02

(52) U.S. Cl. CPC F21V 33/0004; A47G 2009/005; A47G 9/0223

(57) ABSTRACT

A blanket is provided having a fabric sheet having a top surface and a bottom surface. A hood is disposed on the fabric sheet where the hood has a top surface and a bottom surface, an open front portion, and a closed rear and top portion. The open front portion bounded by a brow edge and a pair of cheek edges. At least one lighting apparatus is disposed on the closed rear and top portion of the top surface of the hood adjacent to the brow edge of the open front portion.

### BACKGROUND OF THE INVENTION

The present invention is directed to blankets. More particularly, the present invention is directed to novelty blankets for use, in particular, by children.

Conventional blankets typically offer no other benefits besides being usable as blankets and as security items. However, some blankets may incorporate designs or graphics to make them more attractive, for example, to children. For example, certain blankets may have comic book, cartoon or film characters or other graphics to make them more desirable to certain users.

Moreover, conventional blankets typically do not provide much, if any, utility other than keeping a user warm.

More specifically, most blankets that are available today typically consist of one sheet of plain colored fabric, which often may have a satin border around the perimeter of the blanket.

It is known that children often desire to read in bed prior to going to sleep. Accordingly, it is a primary object of the present invention to provide a blanket that still serves as a functional blanket or pillow, while maintaining functional features making the blanket more desirable to children.

### SUMMARY OF THE INVENTION

A blanket is provided, including a fabric sheet having a top surface and a bottom surface. A hood is disposed on the fabric sheet, the hood having a top surface and a bottom surface, the hood having an open front portion, and a closed rear and top portion, the open front portion bounded by a brow edge and a pair of cheek edges. At least one lighting apparatus is disposed on the closed rear and top portion of the top surface of the hood, adjacent to the brow edge of the open front portion.

The hood may be disposed on a top edge of the fabric sheet. The at least one lighting apparatus may include a pair of lights positioned on the hood to simulate eyes. The fabric sheet may be fabricated from terry material such that the blanket serves as a towel. At least one animal head feature may be disposed on the hood such as a pair of ears, a horn, a nose, a mouth, a pair of ears, horn or horns and the like. The blanket may include a pair of side edges, wherein a pocket is disposed adjacent to each side edge, wherein each pocket is adopted for receipt of a hand of user of the blanket. Each pocket may be disposed on the bottom surface of the blanket.

### BRIEF DESCRIPTION OF THE DRAWINAS

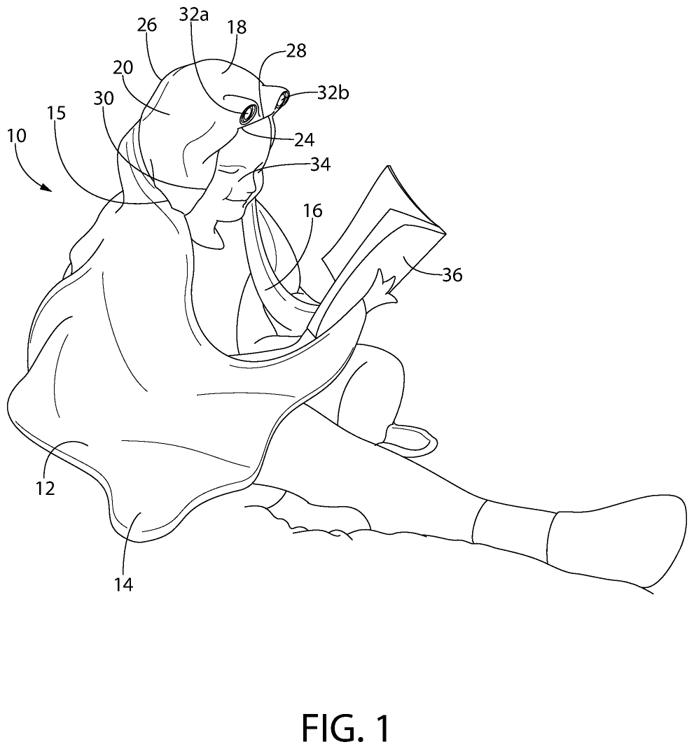

FIG. 1 is a perspective view of a user using a blanket having a lighting apparatus in accordance with an exemplary embodiment of the present invention, shown in use by a user;

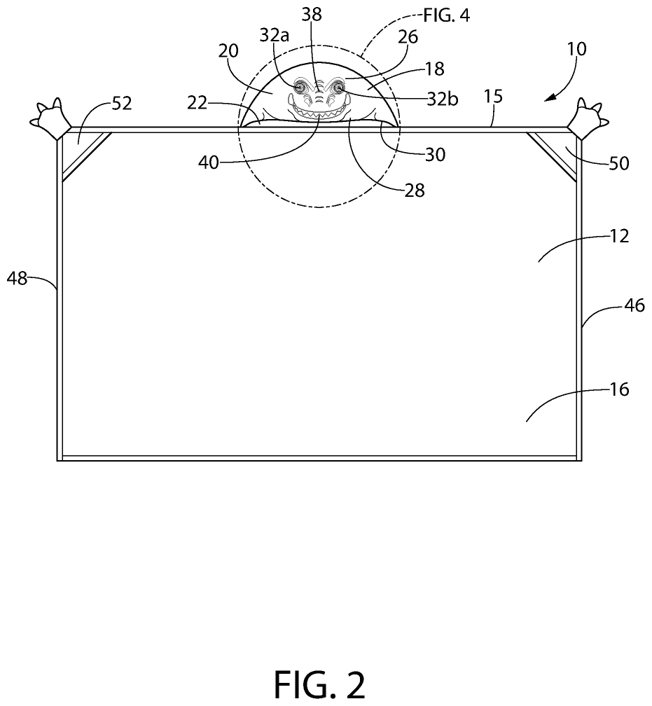

FIG. 2 is a front, elevational view of the blanket having a lighting apparatus of FIG. 1;

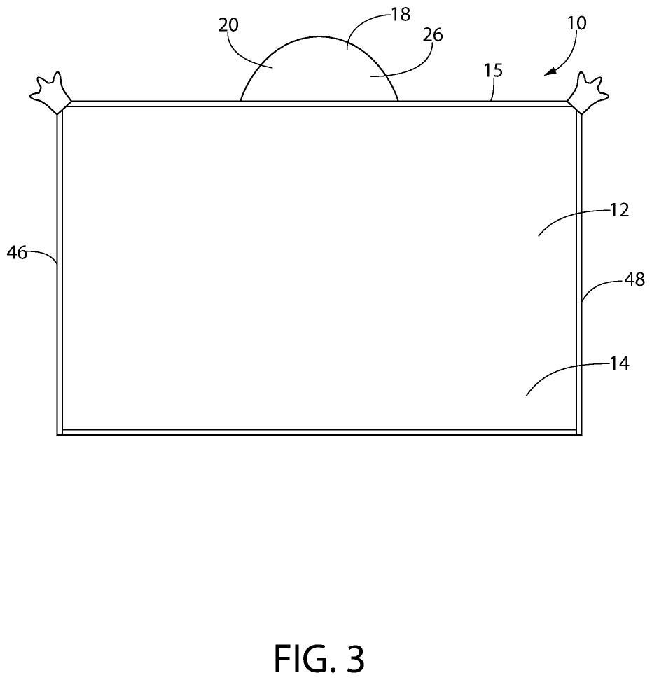

FIG. 3 is a rear, elevational view of the blanket having a lighting apparatus of FIG. 1;

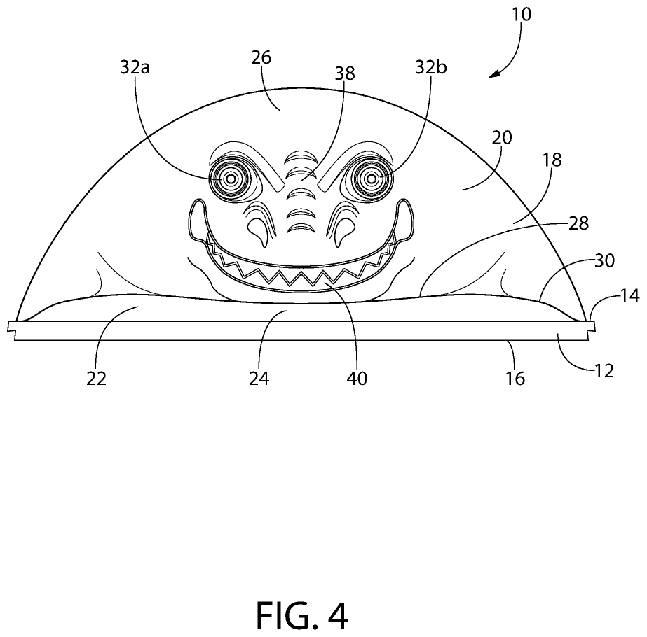

FIG. 4 is a partial top, plan view of the blanket having a lighting apparatus of FIG. 1;

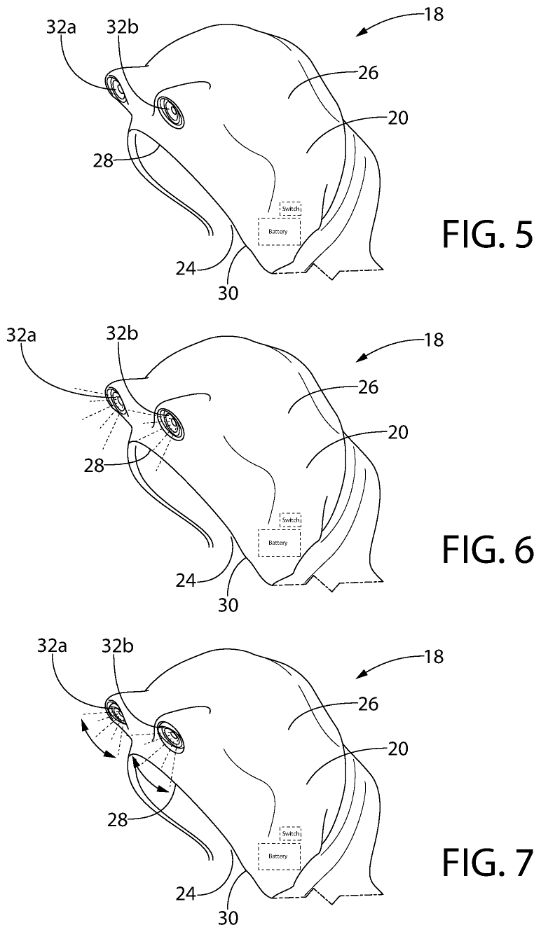

FIG. 5 is a front, perspective view of the hood of a blanket having a lighting apparatus of FIG. 1, taken at detail “FIG. 4” of of FIG. 2;

FIG. 6 is an alternate perspective view of the hood of a blanket having a lighting apparatus of FIG. 5, showing “eyes” located on the hood in a lighted condition, taken at detail “FIG. 4” of FIG. 2;

FIG. 7 is an alternate perspective view of the hood of a blanket having a lighting apparatus of FIG. 5, showing “eyes” located on the hood in a lighted condition, and their ability to swivel, taken at detail “FIG. 4” of FIG. 2; and

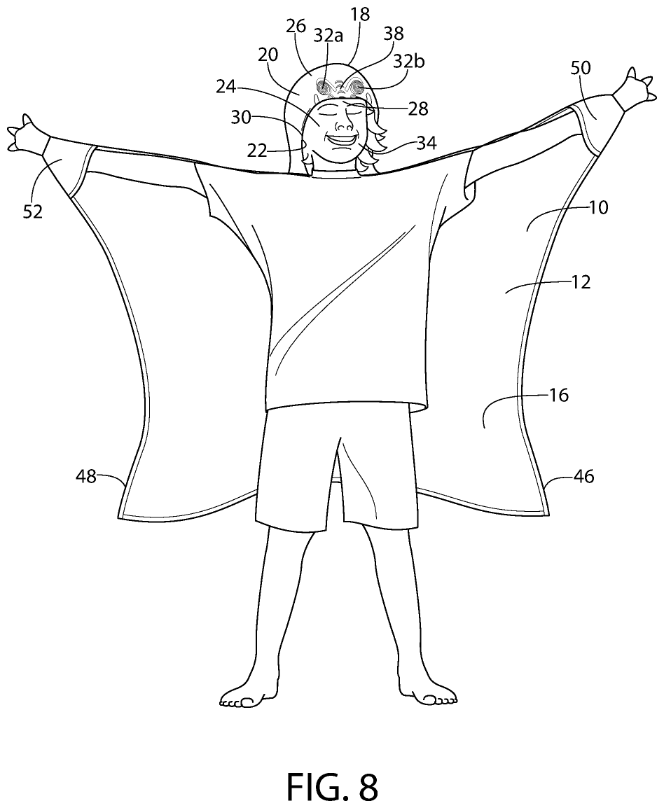

FIG. 8 is a front elevation view of user using the blanket having a lighting apparatus, shown with the user's hands in pockets on the blanket.

### DETAILED DESCRIPTION

For the purposes of the present invention, a “blanket” is intended to broadly include substantially any thin flexible sheet having substantially any outer perimeter shape. The term “fabric sheet” is intended to broadly include substantially any textile or other flexible material, such as, but not limited to cotton, wool, fleece, terry, polyester, acrylic, wool, nylon, down, woven, non-woven, felt, mylar, etc.

Referring now to the drawing figures wherein like reference numbers refer to like elements throughout the several views, there is shown in FIGS. 1-4, a blanket 10 in accordance with an exemplary embodiment of the present invention. The exemplary blanket 10 includes a fabric sheet 12 having a top surface 14 and a bottom surface 16. Attached to a portion of the blanket is a hood 18 disposed on the fabric sheet 12. The hood 18 has a top surface 20 and a bottom surface 22 and has an open front portion 24, and a closed rear and top portion 26. The open front portion 24 is bounded by a brow edge 28 and a pair of cheek edges 30.

Disposed on the closed rear and top portion 26 of the top surface 20 of the hood 18 is at least one lighting apparatus 32a, 32b. In this exemplary embodiment, the lighting apparatus 32a, 32b is disposed adjacent to the brow edge 28 of the open front portion 24.

Preferably, the hood 18 is disposed on or adjacent to a top edge 15 of the fabric sheet 12. However, it may be disposed substantially anywhere on the fabric sheet 12, so long as the blanket is operable as intended.

Preferably, the at least one lighting apparatus 32a, 32b is a pair of lights (for example, LED or incandescent lights) as shown, positioned on the hood 18 to simulate “eyes,” wherein when a user, such as a child, wraps the blanket 10 around his or her body, and raises the hood 18 to cover the user's head 32 (as shown in FIG. 1), the lighting apparatus 32a, 32b appear as “eyes.” While the lighting apparatus 32a, 32b simulate eyes, they are, simultaneously, useful to light an area in front of the user's head 34, such as a book 36 (see FIG. 1) in a similar manner to a headlamp lighting up an area in front of its user for performing tasks or walking in the dark.

As can be seen in FIGS. 5, 6 and 7, the blanket 10 may have a hidden battery pack and switch to control the lighting apparatus 32a, 32b. Note that FIG. 5 depicts the lighting apparatus 32a, 32b in an off position, and FIGS. 6 and 7 depict the lighting apparatus in an on position. Each “eye” of the lighting apparatus 32a, 32b may be independently able to swivel.

The fabric sheet 12 may be fabricated from terry material such that the blanket serves as a towel. The blanket 10 may incorporate ornamental features on the hood 18 such features of a real or imaginary animal, such as animal head feature such as a pair of ears, a horn, a nose 38, a mouth 40, and the like.

As shown in FIG. 8, the blanket 10 may include a pair of side edges 46, 48 wherein a pocket 50, 52 is disposed adjacent to each side edge 46, 48 where each pocket 50, 52 receives a hand of user of the blanket 12 to allow the user to more easily control the blanket 10 while keeping his or her hands substantially hidden. Each pocket 50, 52 may be disposed on the bottom surface 16 of the blanket 10.

It is to be understood that the disclosure teaches just one example of the illustrative embodiment and that many variations of the invention can easily be devised by those skilled in the art after reading this disclosure and that the scope of the present invention is to be determined by the following claims.

1. A blanket, comprising:
(a) a fabric sheet having a top surface and a bottom surface;
(b) a hood disposed on the fabric sheet, the hood having a top surface and a bottom surface, the hood having an open front portion, and a closed rear and top portion, the open front portion bounded by a brow edge and a pair of cheek edges; and
(c) at least one lighting apparatus disposed on the closed rear and top portion of the top surface of the hood adjacent to the brow edge of the open front portion, wherein the lighting apparatus is disposed on the hood to provide light to an area in front of a user's head when the hood is in an up position on the user.

2. The blanket of claim 1, wherein the hood is disposed on a top edge of the fabric sheet

3. The blanket of claim 1, wherein the at least one lighting apparatus comprises a pair of lights positioned on the hood to simulate eyes.

4. The blanket of claim 1, wherein the fabric sheet is fabricated from terry material such that the blanket serves as a towel.

5. The blanket of claim 1, including at least one animal head feature disposed on the hood.

6. The blanket of claim 5, wherein the at least one animal head feature comprises a pair of ears.

7. The blanket of claim 5, wherein the at least one animal head feature comprises at least one horn.

8. The blanket of claim 1, wherein the blanket includes a pair of side edges, wherein a pocket is disposed adjacent to each side edge, each pocket adopted for receipt of a hand of user of the blanket.

9. The blanket of claim 8, wherein each pocket is disposed on the bottom surface of the blanket.

10. The blanket of claim 1, wherein the lighting apparatus includes swivelable lights.
